(19) United States
(12) Patent Application Publication
(10) Pub. No.: US 2025/0260203 A1
(43) Pub. Date: Aug. 14, 2025

(54) SUPPORT SLEEVE FOR FIXING A CABLE SHIELD, CABLE CONNECTOR ARRANGEMENT, AND METHOD FOR PRODUCING A CABLE CONNECTOR ARRANGEMENT

(71) Applicant: Rosenberger Hochfrequenztechnik GmbH & Co. KG, Fridolfing (DE)

(72) Inventors: Hubert SPECKBACHER, Fridolfing (DE); Tobias EGGER, Fridolfing (DE); Matthias SALEMINK, Fridolfing (DE)

(21) Appl. No.: 19/043,600

(22) Filed: Feb. 3, 2025

(30) Foreign Application Priority Data
Feb. 8, 2024 (EP) 24 156 542.3

(51) Int. Cl. H01R 13/6592

(52) U.S. Cl. CPC H01R 13/6592

(57) ABSTRACT

A support sleeve for fixing a cable shield of an electric cable. The support sleeve is designed to receive an end portion of the electric cable, and, starting from a mechanically relaxed state, is compressible counter to an elastic restoring force into an elastically preloaded state in which a first spacing between two opposite reference points on an outer lateral surface of the support sleeve is reduced compared with a second spacing of the two reference points in the mechanically relaxed state. The support sleeve is comprised of a plastics material, the relaxation resistance and/or strength and/or temperature resistance and/or breaking strength of which has been increased by admixing at least one additional material.

### CROSS-REFERENCE TO RELATED APPLICATION

This application claims the benefit and priority of European Patent App. Ser. No. 24 156 542.3 filed on Feb. 8, 2024, the entire disclosure of which is incorporated herein by reference.

### BACKGROUND OF THE INVENTION

The invention relates to a support sleeve for fixing a cable shield of an electric cable, said support shield being designed to receive an end portion of the electric cable, and, starting from a mechanically relaxed state, being compressible counter to an elastic restoring force into an elastically preloaded state.

The invention also relates to a cable connector arrangement, in particular for high-voltage technology, having a support sleeve for fixing a cable shield of an electric cable between the support sleeve and an outer conductor contact element of an electrical connector.

The invention also relates to a method for producing a cable connector arrangement, in particular for producing a cable connector arrangement for high-voltage technology.

In the assembly of cables, the conductors thereof are typically connected to contact elements of a connector. These contact elements serve, during the subsequent use of the connector, to make contact with corresponding mating contact elements of a mating connector. For this purpose, a mechanically and electrically safe and robust, and also durable connection between the cable components and the connector components needs to be created, such that the connector is suitable for as many mating cycles as possible and also for use under adverse environmental conditions. Not least, it should, in particular, also be ensured that the electrical and mechanical connection between the cable components and connector components does not unintentionally come undone in the event of transverse and/or longitudinal tension on the cable.

In order to fix a cable shield or outer conductor of the cable to an outer conductor contact element of the connector, a support sleeve is generally used. As a rule, the cable shield is, for this purpose, fastened in a force-fitting and/or form-fitting manner, in particular clamped, between the support sleeve and the outer conductor contact element. In practice, this is usually realized by pressing or crimping the outer conductor contact element on the support sleeve. As a result, the support sleeve is compressed from its mechanically relaxed basic state, with the result that an elastic preload is created in the support sleeve. As a result, inter alia, of this restoring force or spring force of the support sleeve, the cable shield is ultimately fixed to the outer conductor contact element in a sufficiently mechanically and electrically stable manner.

The demands placed on the electrical and mechanical connection between the cable shield and outer conductor contact element are generally very high, in particular in the case of connectors for the automotive industry or for vehicles (for example in high-voltage technology), and with regard to (data) connectors for high-frequency technology. From an electrical point of view, a low transition resistance and an impedance-matched transition are important. Furthermore, it should be ensured that the components and materials involved maintain their mechanical and electrical properties even in the long term.

In order to meet these requirements, support sleeves are generally in the form of metallic turned parts, preferably made from a nonferrous metal (for example brass or bronze) or from spring steel. Such support sleeves are suitable for the required deformation during the crimping process and empirically particularly suitable for long-term use. The production of the known support sleeves is expensive and complicated, however, and this represents an obstacle to the additional demand of economical producibility of the connectors in mass-production.

### SUMMARY OF THE INVENTION

In light of the known prior art, the object of the present invention is to provide a support sleeve, which continues to have advantageous properties for fixing a cable shield during cable assembly, and which is able to be produced and assembled in particular cost-effectively in mass-production.

A further object of the present invention is to provide a cable connector arrangement which has a mechanically and electrically advantageous support sleeve for fixing a cable shield to an outer conductor contact element, and which is able to be produced and assembled in particular cost-effectively in mass-production.

Finally, a further object of the invention is to provide a method by means of which an electrically and mechanically advantageous cable connector arrangement is able to be produced and assembled in particular cost-effectively in mass-production.

For the support sleeve, the object is achieved by the features set out in claim 1. With regard to the cable connector arrangement, the object is achieved by the features of claim 13, and in relation to the method, it is solved by claim 14.

The dependent claims and features described in the following text relate to advantageous embodiments and variants of the invention.

The invention relates to a support sleeve for fixing a cable shield of an electric cable.

Preferably, the support sleeve is intended for fixing the cable shield in a force-fitting and/or form-fitting manner. In particular, provision may be made for the cable shield to be able to be fixed in a force-fitting and/or form-fitting manner, in particular to be clamped, between the support sleeve and an outer conductor contact element. Preferably, the cable shield is able to be clamped between a clamping face of the support sleeve and a clamping face of the outer conductor contact element, particularly preferably between an outer lateral surface of the support sleeve and an inner lateral surface of the outer conductor contact element.

The outer conductor contact element may be able to be pressed or crimped with the support sleeve or on the support sleeve- or vice versa.

By means of the proposed support sleeve, the cable shield of the electric cable can thus be fixed to the outer conductor contact element of the electrical connector to be mounted on the corresponding cable end of the cable.

Preferably, the electric cable, the outer conductor or cable shield thereof, the electrical connector and/or the outer conductor contact element should not be understood as being part of the claimed support sleeve. However, the applicator reserves the right to also claim combinations of the support sleeve, cable shield, cable, outer conductor contact element and/or connector or said entities in each case individually or separately.

The support sleeve and the outer conductor contact element may also be referred to in the following text as connector components of the connector (in addition to further optional connector components).

According to the invention, the support sleeve is designed to receive an end portion of the electric cable.

The end portion of the electric cable which is intended to be received in the support sleeve may, in particular, be the end portion of the electric cable on which the electrical connector is intended to be mounted. Preferably, the support sleeve is positioned at a defined axial position of the end portion of the electric cable such that the electric cable extends entirely through the support sleeve.

Provision may be made for the cable sheath of the cable to end within the support sleeve such that the support sleeve is preferably also able to be fastened at least partially to the cable sheath, in particular is able to be pressed on the cable sheath. The support sleeve may have a stop against which the corresponding end of the cable sheath butts such that the support sleeve is able to be positioned or oriented optimally relative to the end of the cable sheath. To this end, for example the collar mentioned below or the collar segments of the support sleeve may be suitable. The cable sheath does not necessarily have to end within the support sleeve, however. Provision may also be made, for example, for the cable sheath to extend entirely through the support sleeve or for the support sleeve to directly adjoin the cable sheath along the longitudinal axis of the cable.

The end portion of the electric cable may be unprocessed, but may generally already be partially preassembled/preprocessed when the support sleeve is mounted. In particular, provision may be made for the end portion of the electric cable to be at least partially stripped such that one or more cable components of the electric cable are at least partially exposed and accessible for the connection to the connector components. For example, provision may be made for one or more inner conductors of the electric cable to be exposed from an encasing dielectric at least partially starting from a front, plug-side end. Furthermore, the cable shield of the electric cable may be exposed at least partially from an outer jacket and/or shielding foil, such that it is accessible for the fixing between the support sleeve and outer conductor contact element.

The cable shield may be, in particular, a braided cable shield of the electric cable, i.e., in particular, a braid made up of intertwined individual wires. In principle, however, the term “cable shield” can be understood as being any type of outer conductor of the electric cable, i.e., in particular, also a shielding foil or a combination of a braided cable shield and a shielding foil.

In principle, the proposed support sleeve may be suitable for use with any electric cable. Within the scope of the invention, an electric cable may be provided, inter alia, which has any number of inner conductors or cable cores. For example, an electric cable may have, within the scope of the invention, one inner conductor, two inner conductors, three inner conductors, four inner conductors, or even more inner conductors. Preferably, an electric cable having exactly one inner conductor or exactly two inner conductors is provided. If an electric cable having only one inner conductor is provided, this may be in the form of a coaxial cable. If an electric cable having more than one inner conductor is provided, the cable cores of the cable may be twisted, in the manner of a “twisted pair” cable; the cable cores may also extend in parallel, however, as for example in the case of a “parallel pair” cable.

According to the invention, the support sleeve, starting from a mechanically relaxed state, is compressible counter to an elastic restoring force into an elastically preloaded state. In the elastically preloaded state, which is also referred to as “compressed state” in the following text, the spacing (“first spacing” in the following text) between two opposite reference points on an outer lateral surface and/or inner lateral surface of the support sleeve is reduced compared with the spacing (“second spacing” in the following text) of the two reference points in the mechanically relaxed state.

At this point, it should be mentioned that, in the scope of the described compression of the support sleeve, in addition to the elastic preload/restoring force, permanent or plastic deformation of the support sleeve may optionally also be carried out. As a rule, the compression of the support sleeve results in a plastically and elastically deformed compressed state.

In the case of a round cross section of the support sleeve, which—as will be set out below—is not, however, absolutely necessary, it is thus possible, for example, for the outside diameter and/or inside diameter of the support sleeve to be reduced in the compressed state.

According to the invention, the support sleeve comprises a plastics material, the relaxation resistance and/or strength and/or temperature resistance and/or breaking strength of which has been increased by admixing at least one additional material.

“Relaxation” describes, in this connection, the drop in tension in the support sleeve over time given prior stretching or compression of the support sleeve. Relaxation thus describes the transition of the support sleeve back into its initial state or state of equilibrium following external excitation or disruption.

The proposed support sleeve may preferably have mechanically particularly robust properties and also be extremely aging-resistant. Since a support sleeve for fixing a cable shield of an electric cable is proposed according to the invention, said support sleeve consisting of a plastics material, the support sleeve can be producible much more cost-effectively and easily than the known metallic support sleeves. The proposed support sleeve is therefore suitable in particular for use in a cable connector arrangement, or in a connector, which is producible in mass-production. At the same time, the required mechanical properties of the support sleeve can be increased sufficiently by the proposed admixture of the additional material, and so the support sleeve continues to be readily suitable for the required task (fixing the cable shield).

In one advantageous development of the invention, provision may be made for the support sleeve to consist at least substantially of the plastics material together with admixed additional material. This is not, however, intended to rule out there possibly also being other constituents (but preferably less than 1-10%, particularly preferably less than 0.5-5%, more preferably less than 0.5-2%), in particular those that do not significantly change the main features of the support sleeve (for example impurities or remnants of other materials).

Provision may be made for the support sleeve to be formed integrally or in one piece. The support sleeve may thus be an individual component. Optionally, however, a multi-piece support sleeve may be provided, for example a two-piece support sleeve, which is formed from two half-shells that are able to be joined together.

According to one development of the invention, provision may be made for the additional material to be in the form of fibers and/or balls.

The use of an additional material that is admixed in the form of individual fibers and/or balls to the plastics material has been found to be particularly advantageous. In principle, the additional material may, however, have any forms or geometries within the scope of the invention.

Preferably, the additional material is glass, carbon, aramid, metal (pure metals, but also alloys may be possible) and/or an organic material (for example resins, natural fiber materials, including hemp). In particular glass fibers, carbon fibers or aramid fibers may be very particularly preferred (these materials may also be present in the form of balls, however, as mentioned above, or alternatively in other geometric forms). It should be noted that the abovementioned examples are preferred in principle, but, alternatively, other materials may also be possible for the additional material. In principle, any inorganic or organic materials are possible as additional material. In the scope of the invention, it is furthermore also possible for combinations of several materials to be referred to jointly as “additional material” within the meaning of the present invention.

The additional material is preferably not a plastic.

According to one development of the invention, provision may be made for the plastics material to have a content of the additional material of 10% to 60%, preferably 20% to 50%, more preferably 25% to 40%, particularly preferably 30% to 35%. Very particularly preferably, the plastics material may have a content of the additional material of at least substantially or exactly 30%.

The abovementioned ranges and ratios have been found to be particularly advantageous.

In one development of the invention, provision may be made for the plastics material to be polyamide (PA), polybutylene terephthalate (PBT) or polyetherimide (PEI).

In principle, however, it is also possible for further plastics to be suitable in the scope of the invention, wherein the abovementioned examples may result in a particularly relaxation-resistant support sleeve.

One example of a plastics material having a glass fiber content of 50%, which may be readily suitable in the scope of the invention, is, for example, PBT-GF-50. Further advantageous plastics material-additional material combinations may be, inter alia, PBT-GF-30 or PEI-GF-30.

In one development of the invention, provision may be made for the support sleeve to have at least one longitudinal slot passing at least partially through the support sleeve in an axial direction. The support sleeve can thus be slotted.

Provision may be made for exactly one longitudinal slot to extend entirely through the support sleeve (for example, a C-shaped or partially annular support sleeve can be provided as a result). However, provision may, in particular, also be made for one or more longitudinal slots to extend only partially through the support sleeve.

As a result of the at least one longitudinal slot, the achievable reduction in diameter, i.e. the compressibility of the support sleeve, can be improved, such that the support sleeve is deformable through a greater range. This can improve the fixing of the cable shield between the support sleeve and outer conductor contact element and/or the fixing of the support sleeve to the end portion of the cable, in particular to the cable sheath of the cable.

At this point, it should be mentioned, however, that the invention is also suitable for use with a non-slotted support sleeve, even though the invention is described in the following text mainly with reference to a support sleeve that has one or more longitudinal slots. It is thus alternatively also possible for a support sleeve to be provided that is entirely closed around its circumference, i.e., for example, an annular support sleeve.

At this point, it should also be mentioned that, as an alternative to the at least one longitudinal slot, in principle any incisions/indentations/recesses may be provided, which are arranged in manner distributed around the circumference of the support sleeve in order to specify the compressibility of the support sleeve in a defined manner along its longitudinal extent.

The support sleeve may, in principle, have any cross section. Preferably, the cross section of the support sleeve is elliptical, in particular round. The cross section of the support sleeve may, however, also be rectangular. In particular, any polygonal cross-sectional geometries may be provided. The cross section of the support sleeve may optionally also be asymmetric with respect to its central axis, and may vary along the longitudinal axis (for example narrow, as is set out in detail in the following text).

It may be advantageous to ensure that individual wires of the cable shield do not unintentionally pass into the longitudinal slot in the support sleeve or pass out at some other point.

To this end, in one development of the invention, provision may be made in particular for the longitudinal slot to have a curved or bent and/or stepped profile (with one or more steps) such that a passage (for individual wires of the cable shield) through the longitudinal slot, in particular (but not exclusively) a straight passage, is constricted or blocked. Preferably, the longitudinal slot thus at least does not extend in a straight line along the entire length.

The passage to be blocked may be, in particular, a straight passage passing in an axial direction and/or radial direction of the support sleeve.

Said constriction or blocking may be formed partially at one or more desired axial positions, for example at one or at both axial ends of the support sleeve and/or in a central portion of the support sleeve. The constriction or blocking of the passage may, however, also extend along the entire longitudinal extent of the support sleeve.

In one advantageous development of the invention, provision may be made for the longitudinal slot to be interrupted by a predetermined breaking point or a hinge (in particular a film hinge), such that the longitudinal slot is subdivided into a first section and a second section.

In this way, too, it is possible to ensure that individual wires of the cable shield do not pass in an uncontrolled manner through the longitudinal slots in the support sleeve.

Preferably, the predetermined breaking point or the film hinge are formed within the curved and/or stepped profile of the longitudinal slot, in particular in the region of an axial end portion or end of the longitudinal slot or of the support sleeve, but optionally also in a central axial portion. If the longitudinal slot has a stepped profile, provision may preferably be made for the predetermined breaking point or the film hinge to be formed within at least one step, or a protrusion and/or recess, or “offset” of the longitudinal slot.

In the region of the predetermined breaking point, the support sleeve can thus break off in a defined manner during the compression, with the result that the passage through the longitudinal slot can be completely blocked both in the mechanically relaxed state and in the compressed state. In a corresponding way, a film hinge can also prevent passage, permanently blocked during assembly, through the support sleeve, with simultaneously good compressibility of the support sleeve.

Said predetermined breaking point and the film hinge may further improve the compressibility of the support sleeve.

In one development of the invention, provision may be made for the support sleeve to have at least one pair of longitudinal slots which are offset in the circumferential direction of the support sleeve. Provision may be made in particular for the longitudinal slots of a common pair to extend partially through the support sleeve from opposite axial ends.

Provision may preferably be made for the longitudinal slots of a common pair to extend alongside one another in an axial portion of the support sleeve (preferably to extend parallel to one another at least in one subsegment) such that, in said axial portion, a partition wall segment is formed between the two longitudinal slots in the circumferential direction of the support sleeve.

In this way, a passage for individual wires of the cable shield can thus be blocked by the partition wall segment in particular also in a central axial portion of the support sleeve.

This partition wall segment may preferably (but not necessarily) have a predetermined breaking point or a film hinge, or be in the form of a predetermined breaking point or film hinge.

In summary, it is possible in particular for the following variants to be provided in order to avoid an undesired passage for individual wires of the cable shield of the electric cable through the support sleeve in the longitudinal axial direction and/or radial direction:
the longitudinal slot has such a profile (curved and/or stepped) that edges and/or side walls come into contact within the course of its profile; and/or
the longitudinal slot has such a profile (curved and/or stepped) that a sufficient constriction arises that rules out a passage for an individual wire of the cable shield at least with sufficient probability or extends the passage so as to ensure that the individual wire can no longer emerge from the axial end of the support sleeve or from the longitudinal slot; and/or
the longitudinal slot is interrupted by a predetermined breaking point; and/or
the longitudinal slot is interrupted by a film hinge.

In one development of the invention, provision may be made for the support sleeve to have at least one profile that at least partially narrows in the axial direction, in particular a profile that narrows in an axial end portion or in both axial end portions of the support sleeve in the direction of the corresponding axial end of the support sleeve.

As a result of a narrowing profile, the pressing force for pressing or crimping the support sleeve with the outer conductor contact element and/or the required deformation travel for the support sleeve can be reduced, with the result that the mechanical demands placed on the support sleeve can be reduced. The materials for the support sleeve (plastics material and additional material) may be selected and combined more flexibly as a result.

An at least partially narrowing profile of the support sleeve may also be advantageous in order to create an additional form fit during the subsequent pressing or crimping with the outer conductor contact element, and this can result in better fixing of the support sleeve together with the outer conductor contact element on the electric cable, in particular better fixing of the support sleeve on the cable sheath of the cable (optional).

The narrowing profile may already exist in the mechanically relaxed state of the support sleeve. Alternatively or additionally, provision may be made for the narrowing profile to be created only by the compression of the support sleeve. For this purpose, it may be advantageous (but not necessarily required) for the support sleeve to have a plurality of longitudinal slots which are distributed around the circumference of the support sleeve and which each extend only partially in the axial direction through the support sleeve.

In one development of the invention, provision may be made for the support sleeve to have an at least partially annular collar formed at one axial end of the support sleeve, or a plurality of collar segments arranged in a manner distributed around the circumference at the axial end of the support sleeve, in order in each case to form a stop for a cable sheath of the electric cable.

In this way, the support sleeve can be positioned optimally relative to the cable or cable sheath.

Preferably, the collar segments arranged in a manner distributed around the circumference are spaced apart equidistantly. This is not absolutely necessary, however.

In one development of the invention, provision may also be made for the support sleeve to have at least one internally lateral elevation, for example at least one internally laterally protrusion.

The internally lateral elevation may be advantageous in order to fix the support sleeve better to cable components of the cable by employing a form fit in addition to the force fit. Thus, the support sleeve can be fixed for example better to the cable sheath of the cable and/or to a dielectric/insulator of the cable. In this way, the fixing of the support sleeve to the cable can be improved in particular in the event of cable transverse tension and/or cable longitudinal tension.

The at least one internally lateral elevation may comprise, for example, ribs or barbs.

The invention also relates to a cable connector arrangement, in particular for high-voltage technology, having a support sleeve as set out above and below, the electric cable and an outer conductor contact element of an electrical connector.

For the cable connector arrangement, provision is made for the support sleeve to be arranged on the end portion of the electric cable. Preferably, an exposed portion of the cable shield of the electric cable is positioned on an outer lateral surface of the support sleeve, wherein the outer conductor contact element is positioned on the support sleeve, and the support sleeve and the outer conductor contact element are pressed, preferably crimped, together, such that the support sleeve is compressed in its elastically preloaded state and, as a result, the cable shield is fixed (in a force-fitting and/or form-fitting manner) between the support sleeve and the outer conductor contact element.

The support sleeve is suitable in a particularly advantageous manner for use with high-voltage connectors, wherein the connector type and the use thereof are not necessarily important in principle. The support sleeve may therefore be readily suitable in particular also for use in high-frequency technology, i.e., for example, for data connectors.

The electrical connector should not necessarily be understood as being part of the cable connector arrangement. However, provision may be made for the cable connector arrangement also to have the electrical connector. Furthermore, the cable connector arrangement may have at least one inner conductor contact element, which is electrically and mechanically connected (for example crimped) to at least one inner conductor of the electric cable. In principle, in the scope of the proposed cable connector arrangement, any further components of an electrical connector and/or of an electric cable may be provided.

Optionally, provision may be made for the outer conductor contact element to have undercuts in order to provide an axial form fit/stop for the supper sleeve and thus to improve the mutual axial fixing thereof.

To improve the fixing between the outer conductor contact element and support sleeve, provision may optionally also be made for the outer conductor contact element to have internally lateral elevations and/or depressions, and/or for the support sleeve to have externally lateral elevations and/or depressions, for example at least one internally lateral protrusion and/or recess, for example engagement hooks, ribs, flutes and/or barbs.

Provision may optionally be made for the support sleeve to have an at least partially annular flange formed at one axial end, or a plurality of flange segments arranged in a manner distributed around the circumference (preferably distributed equidistantly around the circumference) at the axial end of the support sleeve, in order in each case to form a stop for a connector component or cable component (in particular a stop for the outer conductor contact element). In this way, the support sleeve can be positioned optionally relative to connector components and/or cable components.

The invention also relates to a method for producing a cable connector arrangement, in particular for producing a cable connector arrangement for high-voltage technology, having at least the following method steps:
providing an electric cable, which has a partially exposed cable shield in one end portion;
providing a support sleeve, which comprises a plastics material, the relaxation resistance and/or strength and/or temperature resistance and/or breaking strength of which has been increased by admixing at least one additional material;
providing an outer conductor contact element of an electrical connector;
positioning the end portion of the electric cable in the support sleeve;
positioning the exposed portion of the cable shield on an outer lateral surface of the support sleeve; and
fixing the cable shield (in a force-fitting and/or form-fitting manner) between the support sleeve and the outer conductor contact element by pressing, preferably crimping, the outer conductor contact element on the support sleeve such that the support sleeve, starting from a mechanically relaxed state, is compressed counter to an elastic restoring force into an elastically preloaded state in which a spacing between two opposite reference points on the outer lateral surface of the support sleeve is reduced compared with the spacing of the two reference points in the mechanically relaxed state.

Advantageously, with the proposed method, particularly economical and mass-market support sleeves are able to be produced. The adaptation of the process may be particularly simple for different cable cross sections, for example in that the thickness of the support sleeve or the wall thickness is adapted appropriately.

As a result of the proposed method, a support sleeve can be provided which, regardless of the wall or material thickness, has at least approximately constant material properties.

Provision may be made for the support sleeve to be produced by injection molding. In principle, however, other techniques may also be suitable for producing the proposed plastics support sleeve.

The pressing or crimping can take place such that the support sleeve, after pressing/crimping, has a radial reduction in size/narrowing in each case in at least one angular segment. The slotting, already mentioned above, in the support sleeve (cf. longitudinal slots) may be advantageous for this, in order to optionally achieve an even greater diametric narrowing. In this way, it is possible, for example, in addition to the outer conductor crimp, for pressing or crimping to occur at the same time on the cable sheath of the cable, with the result that, at best, a cable tension safeguard can be dispensed with.

In one development of the invention, provision may be made that, to press the outer conductor contact element, an at least partially annular pressing tool is used, which creates, around the circumference, an at least approximately curved impression in the outer conductor contact element, preferably an at least 6-edged, particularly preferably at least 10-edged, more preferably at least 14-edged impression, and very particularly preferably an edge-free impression.

As a result of a crimp that is as multi-edged as possible, approximating a curved impression as far as possible, right down to an edge-free crimp, or by using a corresponding pressing tool, the deformation of the support sleeve can take place in a particularly careful manner. For example, a so-called “lamellar crimp” can be provided. In principle, the support sleeve according to the invention is suitable, however, for any crimping methods and crimping tools.

Features that have been described in conjunction with one of the subjects of the invention, namely provided by the support sleeve according to the invention, the cable connector arrangement according to the invention, and the method, are also advantageously able to be implemented for the other subjects of the invention. Likewise, advantages that have been mentioned in conjunction with one of the subjects of the invention can also be understood in relation to the other subjects of the invention.

In addition, it should be noted that terms such as “comprising”, “having” or “with” do not rule out other features or steps. Furthermore, terms such as “one”, “a/an” or “the”, which indicate a singular number of steps or features, do not rule out a plurality of features or steps—and vice versa.

In a puristic embodiment of the invention, provision may also be made, however, for the features introduced by the terms “comprising”, “having” or “with” in the invention to be exhaustively listed. Accordingly, one or a plurality of lists of features can be considered to be complete in the scope of the invention, for example considered for each claim in each case. The invention may, for example, consist only of the features mentioned in claim 1.

It should be noted that designations such as “first” or “second” etc. are primarily used for reasons of distinguishing between respective device or method features and are not necessarily intended to indicate that features are mutually dependent or are linked to one another.

It should also be noted that the values and parameters described herein include deviations or fluctuations of ±10% or less, preferably ±5% or less, more preferably ±1% or less, and very particularly preferably ±0.1% or less of the value or parameter mentioned in each case, as long as these deviations are not ruled out on implementing the invention in practice. The indication of ranges through the use of starting and end values also includes all those values and fractions that are included by the range mentioned in each case, in particular the starting and end values and a respective mean value.

The invention also relates to a support sleeve, independent of claim 1, of a cable connector, said support sleeve being compressible and exhibiting a plastics material (preferably, said support sleeve consists at least substantially of the plastics material), with the relaxation resistance and/or strength and/or temperature resistance and/or breaking strength of said support sleeve having been increased by defined material, structural and/or geometric measures. For example, said support sleeve may have a suitable geometric shape in order to dissipate external forces advantageously and carefully in the scope of the compression of the support sleeve (for example, an at least approximately elliptical, in particular round cross-sectional shape may be readily suitable for this). For example, said support sleeve may be designed for a form fit with the outer conductor contact element, for example be formed partially in a conical manner or have an annularly extending groove or bead. For example, provision may also be made for said support sleeve to have ribs, barbs, flutes or other kinds of roughness on the contact face facing the outer conductor contact element. The further features of claim 1 and of the dependent claims, and the features described in the present description relate to advantageous embodiments and variants of this further support sleeve, and the applicant expressly reserves the right to claim this separately. Furthermore, the applicant reserves the right to claim a method for producing the support sleeve mentioned in this paragraph, on the basis of the method already mentioned above, and a cable connector arrangement that has said support sleeve.

### BRIEF DESCRIPTION OF THE DRAWINGS

Exemplary embodiments of the invention will be described in more detail in the following text with reference to the drawings.

The figures each show preferred exemplary embodiments, in which individual features of the present invention are illustrated in combination with one another. Features of one exemplary embodiment are also able to be implemented separately from the other features of the same exemplary embodiment and can accordingly be readily combined with features of other exemplary embodiments by a person skilled in the art to form further meaningful combinations and sub-combinations.

In the figures, functionally identical elements are provided with the same reference signs.

In the figures, schematically:

FIG. 1: shows an illustration in longitudinal section of a cable connector arrangement having a support sleeve, an electric cable, and an outer conductor assembly according to one exemplary embodiment of the invention;

FIG. 2 shows a perspective illustration of the cable connector arrangement according to FIG. 1, wherein the outer conductor contact element and the insulator element have been omitted;

FIG. 3 shows an illustration in longitudinal section of a cable connector arrangement having a support sleeve according to a further exemplary embodiment of the invention;

FIG. 4 shows a perspective individual illustration of a non-slotted support sleeve with internally lateral ribs, according to one exemplary embodiment of the invention;

FIG. 5 shows a perspective individual illustration of a slotted support sleeve, having a stepped profile of the longitudinal slot, according to one exemplary embodiment of the invention;

FIG. 6 shows a perspective individual illustration of a further slotted support sleeve having a stepped profile of the longitudinal slot, according to one exemplary embodiment of the invention;

FIG. 7 shows a perspective individual illustration of a further slotted support sleeve, having a stepped profile of the longitudinal slot, according to one exemplary embodiment of the invention;

FIG. 8 shows a perspective individual illustration of a further slotted support sleeve having a stepped profile of the longitudinal slot, according to one exemplary embodiment of the invention;

FIG. 9 shows a perspective individual illustration of a further slotted support sleeve having a stepped profile of the longitudinal slot, wherein a film hinge or a predetermined breaking point has been formed within one step in the profile, according to one exemplary embodiment of the invention;

FIG. 10 shows a perspective individual illustration of a further slotted support sleeve having a film hinge or a predetermined breaking point, according to one exemplary embodiment of the invention;

FIG. 11 shows a perspective individual illustration of a support sleeve having two pairs of longitudinal slots that are offset in the circumferential direction, according to one exemplary embodiment of the invention;

FIG. 12 shows a perspective individual illustration of a multiply slotted support sleeve for creating a conical profile by compression of the support sleeve, having internally lateral barbs, according to one exemplary embodiment of the invention;

FIG. 13 shows a sectional side illustration of the support sleeve according to FIG. 12 in its mechanically relaxed state;

FIG. 14 shows a sectional side illustration of the support sleeve according to FIG. 12 in its elastically preloaded state;

FIG. 15 shows an illustration in longitudinal section of a cable connector arrangement having a conical support sleeve according to a further exemplary embodiment of the invention;

FIGS. 16-18 show respective sectional side illustrations of different variants of conical support sleeves according to exemplary embodiments of the invention; and

FIG. 19 shows a support sleeve according to one exemplary embodiment with a narrowing in its central axial portion.

### DETAILED DESCRIPTION OF THE ENABLING EMBODIMENTS

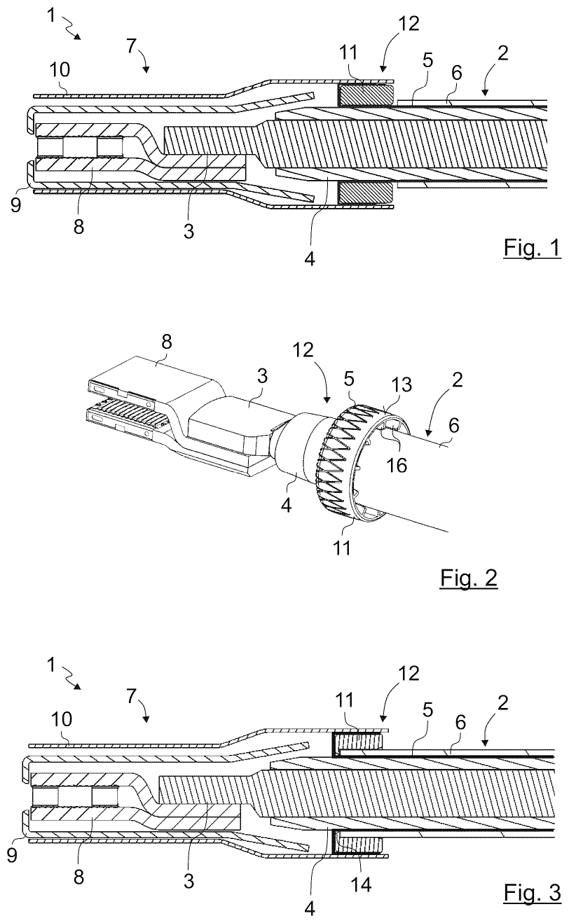

FIGS. 1 and 2 show a cable connector arrangement 1 according to a first exemplary embodiment of the invention. The cable connector arrangement 1 illustrated in the figures is suitable in particular for use in high-voltage technology, although the invention should not be understood as being limited to this application and may also, for example, be advantageously suitable for use with data connectors and high-frequency technology.

The cable connector arrangement 1 has an electric cable 2, which is, for example, a coaxial cable. The electric cable 2 has an inner conductor 3, which is encased by a dielectric 4, on which a cable shield 5 extends. In the exemplary embodiment, the cable shield 5 is a braided cable shield formed from a plurality of individual wires. Around the cable shield 5 there extends an electrically insulating cable sheath 6. As illustrated, the electric cable 2 is partially stripped in order to make the inner conductor 3 and the cable shield 5 accessible for assembly with an electrical connector 7. The inner conductor 3 of the cable 2 is compacted in a planar form and connected, for example welded, to an inner conductor contact element 8 of the connector 7, wherein the specific type of connection of the inner conductor 3 and the inner conductor contact element 8 is not particularly important in the scope of the invention. The inner conductor contact element 8 of the connector 7 is at least partially surrounded by an insulator element 9 in order to provide protection against contact and electrical separation between an outer conductor contact element 10 of the connector 7 and the inner conductor contact element 8. The insulator element 9 and the outer conductor contact element 10 are not illustrated in FIG. 2 for clearer illustration.

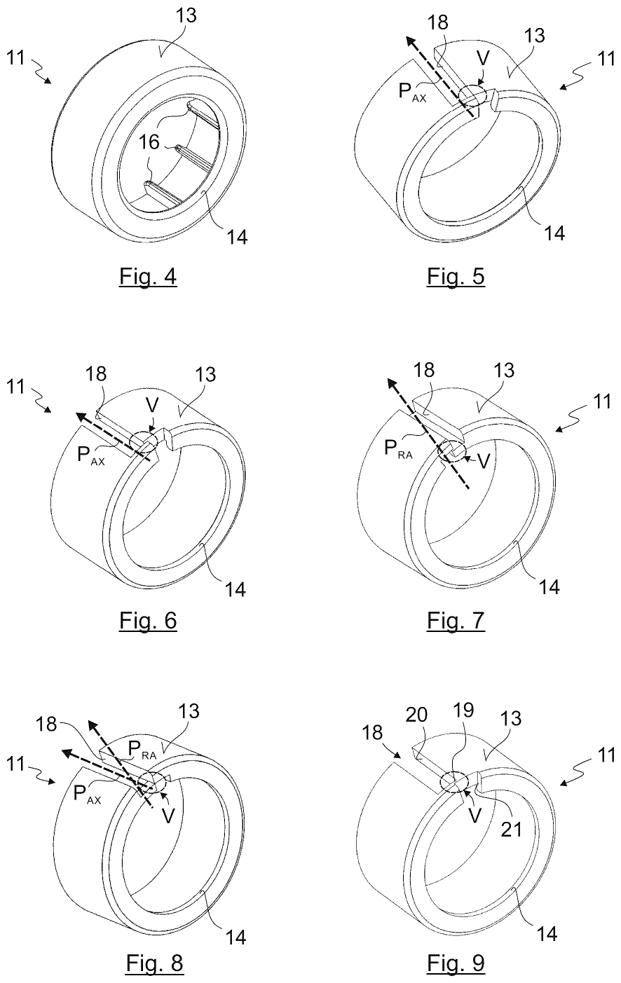

The cable connector arrangement 1 has a support sleeve 11 for fixing the cable shield 5. To this end, the support sleeve 11 is arranged on the corresponding end portion 12 of the electric cable 2. The exposed portion of the cable shield 5 of the electric cable 2 is positioned on an outer lateral surface 13 of the support sleeve 11 (cf. FIG. 2 and, for example, FIG. 4) and may, for this purpose, be folded for example rearwardly over the support sleeve 11, as illustrated. The outer conductor contact element 10 is finally positioned and pressed (in particular crimped) on the support sleeve 11 such that the support sleeve 11, starting from a mechanically relaxed state, is compressed counter to an elastic restoring force into an elastically preloaded state in which a first spacing A₁ between two opposite reference points P_{Ref} on the outer lateral surface 13 of the support sleeve 11 is reduced compared with a second spacing A₂ of the two reference points P_{Ref} in the mechanically relaxed state (cf., for example, FIGS. 13 and 14). As a result, the cable shield 5 can finally be fixed securely between the support sleeve 11 and the outer conductor contact element 10.

In the scope of the invention, provision is made for the support sleeve 11 to exhibit a plastics material, the relaxation resistance and/or strength and/or temperature resistance and/or breaking strength of which has been increased by defined material, structural and/or geometric measures. In particular, this can be achieved by admixing at least one additional material to the plastics material.

Preferably, the support sleeve 11 consists at least substantially of the plastics material and the admixed additional material. The additional material may be, in particular, in the form of fibers and/or balls. Preferably, glass, carbon or aramid can be provided as additional material, wherein, in particular, the use of glass fibers, carbon fibers or aramid fibers has been found to be particularly suitable. It may also be advantageous for the plastics material to have a content of the additional material of 10% to 60%, preferably 20% to 50%, more preferably 25% to 40%, particularly preferably 30% to 35%. In a very particularly preferred variant, the content of the additional material may be at least substantially 30%.

The plastics material may preferably be a relaxation-resistant plastic, for example polyamide, polybutylene terephthalate or polyetherimide.

To press the outer conductor contact element 10 on the support sleeve 11, an at least partially annular pressing tool (not illustrated) can be used, which creates, around the circumference of the outer conductor contact element 10, an at least approximately curved impression in the outer conductor contact element 10, i.e. preferably an impression with as many edges as possible. Preferably, at least a 6-edged crimp, particularly preferably at least a 10-edged crimp, more preferably at least a 14-edged crimp, and very particularly preferably an edge-free crimp can be provided. In principle, however, any pressing tools and crimping methods can be used in the scope of the production method according to the invention.

The support sleeve 11 may in principle be fixed to any cable component of the cable 2, i.e., for example, directly to the cable shield 5, as illustrated in FIGS. 1 and 2, or alternatively also directly (entirely or partially) to the cable sheath 6 of the cable 2 (cf. FIG. 3 and FIG. 15). In the case of fixing partially to the cable sheath 6 of the cable 2, it may be advantageous for the support sleeve 11 to have an at least partially annular collar 14 formed at one axial end (cf., inter alia, FIG. 3 and FIG. 4), in order to form a stop for the cable sheath 6 of the electric cable 2. In this way, the support sleeve 11 can be fasted to the cable 2 at a defined axial position. As an alternative to a partially annular collar 14, it is also possible, for example, for a plurality of collar segments 15 that are arranged in a manner distributed around the circumference to be provided at the axial end of the support sleeve 11, as indicated in FIG. 11. In principle, a collar 14 or collar segments 15 can also be entirely omitted (cf., for example, FIGS. 1 and 2).

In order to further improve the retention or fixing between the support sleeve 11 and the corresponding cable component of the cable 2, in particular the cable sheath 6 of the cable 2, it is optionally possible to provide internally lateral elevations in the support sleeve, for example a plurality of ribs 16 (cf. FIGS. 2 and 4) or barbs 17 (cf. FIG. 12) distributed around the circumference. The resistance of the cable connector arrangement 1 to transverse and/or longitudinal tension can be greatly increased as a result.

The proposed support sleeve 11 may have a cross section that is entirely closed in the circumferential direction and therefore be formed for example in an annular manner, as illustrated in FIGS. 2 and 4. Preferably, however, a slotted support sleeve 11 is provided, i.e. a support sleeve 11 that has at least one longitudinal slot 18 extending at least partially through the support sleeve 11 in the axial direction, as illustrated in FIGS. 5 to 14. By means of the at least one longitudinal slot 18, the deformability of the support sleeve 11 can be increased.

In order to avoid a situation in which, in the case of a slotted support sleeve 11, individual wires of the cable shield 5 of the cable 2 pass in an uncontrolled manner through the longitudinal slot 18 in the axial direction and/or radial direction and thus pierce or damage for example an end seal in the subsequent connector 7, or represent a risk of injury to the subsequent user, various measures may be provided, some of which will be discussed in the following text. At this point, it should be mentioned that sometimes applications may also be provided in which the measures mentioned below are not necessary since it is not important whether or not individual wires of the cable shield 5 pass through the longitudinal slot 18 or the longitudinal slots 18 in the support sleeve 11. The invention should therefore not be understood as being limited to one or more of the following variants. In particular, the following variants can also be combined with one another as desired.

For example, provision may be made for the longitudinal slot 18 to have a stepped profile V, as is illustrated for example in FIGS. 5 and 6. Alternatively or in addition to a stepped profile V, a continuous curved profile V (not illustrated in the figures) can also be provided in principle. In this way, a straight passage P_{AX}, P_{RA} through the longitudinal slot 18, in FIGS. 5 and 6 a straight passage P_{AX} in the axial direction, through the support sleeve 11 can be blocked (cf. FIG. 5) or constricted (cf. FIG. 6). Although a continuous axial passage P_{AX} through the support sleeve 11 is present for example in FIG. 6, it is nevertheless virtually impossible for an individual wire of the cable shield 5 to pass entirely through the support sleeve 11 through the constricted longitudinal slot 18. At the same time, in the proposed variants according to FIGS. 5 and 6, it is still possible to compress the support sleeve 11 over a relatively long spring travel. As is clear from FIGS. 5 and 6, it may already be sufficient, in order to block the axial passages P_{AX}, for this to be blocked only in an axial portion (in FIGS. 5 and 6 at the cable-lateral end portion of the support sleeve 11). In this case, it is not particularly important at which axial point the passage P_{AX} is blocked or constricted, as will be discussed in the following text.

As an alternative to a stepped or curved profile V of the longitudinal slot 18 for blocking an axial passage P_{AX}, the longitudinal slot 18 can also have a stepped or curved profile V for blocking a radial passage P_{RA}, as is intended to be illustrated in FIG. 7. In this way, it is possible to avoid a situation in which individual wires of the cable shield 5 pass in an uncontrolled manner from the inner side of the support sleeve 11 in the radial direction along a radial passage P_{RA} through the longitudinal slot 18 and consequently project for example out of the axial end of the support sleeve 11. This, too, can also occur only partially along the longitudinal extent of the support sleeve 11, as illustrated in FIG. 8.

In FIG. 8, both an axial passage P_{AX} and a radial passage P_{RA} are blocked by the profile (V) of the longitudinal slot 18.

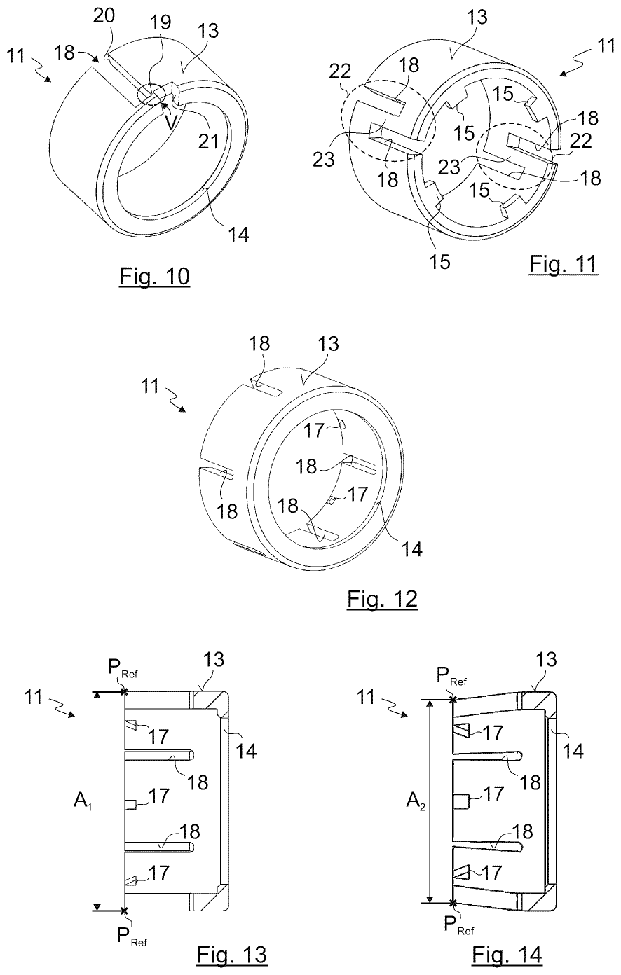

Provision may also be made for the longitudinal slot 18 to be interrupted by a predetermined breaking point 19 or a film hinge, in particular within its curved and/or stepped profile (V), preferably within the step or the protrusion and/or recess in the longitudinal slot 18, as indicated in FIGS. 9 and 10. In this way, the longitudinal slot 18 can be subdivided into a first section 20 and into a second section 21.

As already mentioned above, it is not particularly important here at which axial point along the longitudinal extent of the support sleeve 11 a constriction or blockage of the passage P_{AX}, P_{RA} through the support sleeve 11 occurs. While, in the figures discussed above, preferably blocking at an axial end of the support sleeve 11 is provided, FIG. 11 is intended to indicate how an axial passage P_{AX} in the case of a slotted support sleeve 11 can be blocked in a central portion of the support sleeve. The support sleeve 11 illustrated in FIG. 11 has two pairs 22 of longitudinal slots 18 that are offset in the circumferential direction of the support sleeve 11, each extend partially through the support sleeve 11 from opposite axial ends, and extend alongside one another in an axial portion of the support sleeve 11 such that, in said axial portion, a partition wall segment 23 is formed between the two longitudinal slots 18 in the circumferential direction of the support sleeve 11. This partition wall segment 23 may optionally also be in the form of a predetermined breaking point 19 or film hinge (although this is not absolutely necessary and is also not illustrated in FIG. 11). As a result of the compression of the support sleeve 11 during assembly on the cable 2, or within the outer conductor contact element 10, the support sleeve 11 can thus be compressed in a curved manner, generally approximately in an “S-shape”, along the pairs 22 of longitudinal slots 18.

The pairs of longitudinal slots 18 that are offset in the circumferential direction of the support sleeve 11 can optionally also be suitable for bringing about a narrowing in the support sleeve 11 during the pressing of the support sleeve 11 with the outer conductor contact element 10.

A narrowing of the support sleeve 11 at at least one axial end (or alternatively also in a central axial portion) may be advantageous in order, in addition to a force fit, to also create a form fit between the support sleeve 11, outer conductor contact element 10 and/or cable component, for example cable sheath 6. In this regard, FIGS. 12 to 14 illustrate, for example, a support sleeve 11 with a plurality of longitudinal slots 18, wherein the longitudinal slots 18 are distributed around the circumference of the support sleeve 11 and each extend only partially in the axial direction through the support sleeve 11. In this way, the narrowing profile can be created by compression of the support sleeve 11 at the axial end of the support sleeve 11, said end having the longitudinal slots 18. FIG. 13 shows the support sleeve 11 in its non-compressed state, and FIG. 14 shows it in its compressed state. As already mentioned above, it is not absolutely necessary, however, for the support sleeve 11 to have one or more longitudinal slots 18 in order to create the narrowing profile, although the longitudinal slots 18 may be advantageous in this regard.

Furthermore, FIG. 15 shows a cable connector arrangement 1 with a conically compressed support sleeve 11 in its rear axial end facing the cable 2. In order to further improve the form fit between the outer conductor contact element 10 and support sleeve 11, an undercut 24 may optionally also be provided in the outer conductor contact element 10 (illustrated by dashed lines in FIG. 15).

At this point, it should be mentioned that a narrowing profile of the support sleeve 11 does not necessarily have to arise only during the compression. The narrowing profile may, for example, already exist in the mechanically relaxed state of the support sleeve 11. Furthermore, it is also not absolutely necessary for the support sleeve 11 to be slotted at all for compression, as is illustrated in FIGS. 12 to 14. A narrowing profile of the support sleeve 11 may therefore also be pressed into a non-slotted support sleeve during assembly/the crimping process.

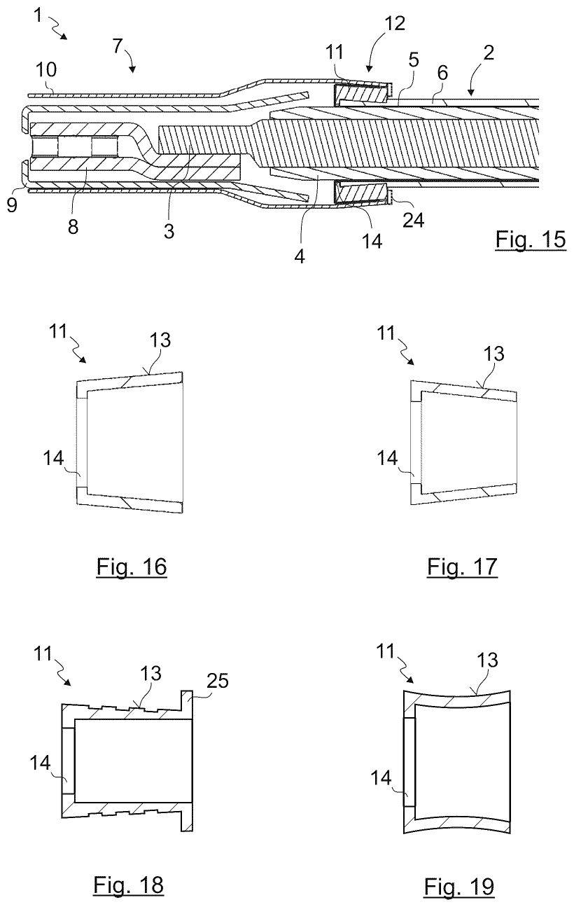

A few further examples of support sleeves 11 having a narrowing are indicated in FIGS. 16 to 19. FIGS. 16 to 18 show examples of variants having a narrowing starting from one axial end of the support sleeve 11 and FIG. 19 shows a narrowing in a central axial portion. Rather than the concave profile illustrated in FIG. 19, a convex externally lateral profile of the support sleeve 11 may also optionally be suitable in order to establish or improve the form fit with the outer conductor contact element 10.

In order to improve the fixing between the outer conductor contact element 10 and support sleeve 11, provision may optionally be made for the outer conductor contact element 10 to have internally lateral elevations and/or recesses (not illustrated in the figures). Alternatively or additionally, provision may be made for the support sleeve 11 to have externally lateral elevations and/or recesses on its outer lateral surface 13, as indicated for example in FIG. 18. The abovementioned improvement measures are, of course, able to be realized independently of the narrowing likewise illustrated in FIG. 18 or of other features of FIG. 18.

Provision may optionally also be made for the support sleeve 11 to have an at least partially annular flange 25 formed at one axial portion (in particular at one axial end), or a plurality of flange segments (not illustrated) arranged in a manner distributed around the circumference, in order to form a stop region for a connector component or cable component—in particular a stop for the outer conductor contact element 10. In this way, the support sleeve 11 can be positioned optimally relative to connector components and/or cable components—in particular to the outer conductor contact element 10. The flange 25 or the flange segments or the stop region is, of course, able to be realized independently of the narrowing likewise illustrated in FIG. 18 or of other features of FIG. 18.

What is claimed is:

1. A support sleeve for fixing a cable shield of an electric cable, wherein the support sleeve is designed to receive an end portion of the electric cable, and, starting from a mechanically relaxed state, is compressible counter to an elastic restoring force into an elastically preloaded state in which a first spacing between two opposite reference points on an outer lateral surface of the support sleeve is reduced compared with a second spacing of the two reference points in the mechanically relaxed state, and wherein the support sleeve comprises a plastics material, the relaxation resistance and/or strength and/or temperature resistance and/or breaking strength of which has been increased by admixing at least one additional material.

2. The support sleeve according to claim 1, wherein the support sleeve consists substantially of the plastics material with the admixed additional material.

3. The support sleeve according to claim 1, wherein the additional material is in the form of fibers and/or balls.

4. The support sleeve according to claim 3, wherein the additional material is comprised of glass, carbon, aramid, metal and/or an organic material.

5. The support sleeve according to claim 1, wherein the plastics material has a content of the additional material of 10% to 60%.

6. The support sleeve according to claim 5, wherein the plastics material has a content of the additional material of 30 to 35%.

7. The support sleeve according to claim 1, wherein the plastics material is comprised of polyamide, polybutylene terephthalate or polyetherimide.

8. The support sleeve according to claim 1, further comprising at least one longitudinal slot passing at least partially through the support sleeve in an axial direction.

9. The support sleeve according to claim 8, wherein the at least one longitudinal slot has a curved and/or stepped profile such that a straight passage through the longitudinal slot, in particular a straight passage passing in an axial direction and/or radial direction of the support sleeve, is constricted or blocked.

10. The support sleeve according to claim 9, wherein the at least one longitudinal slot is interrupted within the curved and/or stepped profile by a predetermined breaking point or a film hinge, such that the longitudinal slot is subdivided into a first section and a second section.

11. The support sleeve according to claim 1, further comprising at least one pair of longitudinal slots which are offset in the circumferential direction of the support sleeve and extend partially through the support sleeve from opposite axial ends, and which extend alongside one another in an axial portion of the support sleeve such that, in said axial portion, a partition wall segment is formed between the two longitudinal slots in the circumferential direction of the support sleeve, wherein the partition wall segment preferably has a predetermined breaking point or a film hinge.

12. The support sleeve according to claim 1, further comprising at least one profile that at least partially narrows in the axial direction, in particular the at least one profile narrowing in an axial end portion of the support sleeve in the direction of the corresponding axial end of the support sleeve, wherein preferably
the narrowing profile already exists in the mechanically relaxed state of the support sleeve; and/or
the support sleeve has a plurality of longitudinal slots which are distributed around the circumference of the support sleeve and which each extend only partially in the axial direction through the support sleeve, such that the narrowing profile can be created by compressing the support sleeve.

13. The support sleeve according to claim 1, further comprising an at least partially annular collar formed at one axial end of the support sleeve, or a plurality of collar segments arranged in a manner distributed around the circumference at the axial end of the support sleeve, in order in each case to form a stop for a cable sheath of the electric cable.

14. The support sleeve according to claim 1, further comprising at least one internally lateral elevation, preferably a plurality of internally lateral elevations, in particular ribs or barbs, distributed around the circumference.

15. A cable connector arrangement, in particular for high-voltage technology, having a support sleeve according to claim 1, the electric cable and an outer conductor contact element of an electrical connector, wherein the support sleeve is arranged on the end portion of the electric cable, and an exposed portion of the cable shield of the electric cable is positioned on the outer lateral surface of the support sleeve, wherein the outer conductor contact element is positioned on the support sleeve and pressed, preferably crimped, such that the support sleeve is compressed in its elastically preloaded state and, as a result, the cable shield is fixed between the support sleeve and the outer conductor contact element.

16. A method for producing a cable connector arrangement, in particular for producing a cable connector arrangement for high-voltage technology, having at least the following method steps:
providing an electric cable, which has a partially exposed cable shield in one end portion;
providing a support sleeve, which comprises a plastics material, the relaxation resistance and/or strength and/or temperature resistance and/or breaking strength of which has been increased by admixing at least one additional material;
providing an outer conductor contact element of an electrical connector;
positioning the end portion of the electric cable in the support sleeve;
positioning the exposed portion of the cable shield on an outer lateral surface of the support sleeve; and
fixing the cable shield between the support sleeve and the outer conductor contact element by pressing, preferably crimping, the outer conductor contact element on the support sleeve such that the support sleeve, starting from a mechanically relaxed state, is compressed counter to an elastic restoring force into an elastically preloaded state in which a first spacing between two opposite reference points on the outer lateral surface of the support sleeve is reduced compared with a second spacing of the two reference points in the mechanically relaxed state.

17. The method according to claim 16, wherein to press the outer conductor contact element, an at least partially annular pressing tool is used, which creates, around the circumference, an at least approximately curved impression in the outer conductor contact element.

18. The method according to claim 17, wherein the at least approximately curved impresent is an at least 6-edged impression.

19. The method according to claim 18, wherein the at least approximately curved impression is an edge-free impression.
